(19) United States
(12) Patent Application Publication
(10) Pub. No.: US 2010/0015305 A1
(43) Pub. Date: Jan. 21, 2010

(54) Turkey seasonings, toppings and bits, and methods of making same

(76) Inventor: David S. Grow, Duncannon, PA (US)

Correspondence Address: Marc J. Farrell, Esq.;Central PA Patent & Trademark Law Group, LLC, P.O. Box 2441, Harrisburg, PA, 17105-2441, US

(21) Appl. No.: 12/218,987

(22) Filed: Jul. 18, 2008

(51) Int. Cl. A23L 1/318; A23L 1/315

(52) U.S. Cl. 426/302; 426/644

(57) ABSTRACT

Food toppings and seasonings made from turkey meat, including turkey “bacon” bits and methods for their manufacture are provided. While turkey has long been an attractive alternative to red meat in nearly every food sector, there is presently no suitable alternative to the traditional pork-based bacon bits or the imitation bacon bits made from vegetable protein. Consumption of any type of red meat, including pork-based products such as genuine bacon bits, raises significant health concerns given the connection between red meat consumption and an increased risk of developing cardiovascular disease, cancer, and other significant threats to one's health. While imitation bacon bits generally do not raise such concerns due to their much lower saturated fat content, such bits often fail to match genuine bacon bits for taste, texture and appearance. The turkey bits of the present invention and the processes for making same provide a healthier replacement for pork-based bacon bits, without in any way sacrificing taste, texture or appearance.

### CROSS REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, TABLE, OR COMPUTER PROGRAM LISTING COMPACT DISC APPENDIX

Not Applicable

### BACKGROUND OF THE INVENTION

The present invention relates generally to toppings and seasonings made from turkey meat, and processes for making same. More particularly, the present invention relates to turkey “bits” and a process for making same.

For many decades now, heart disease and cancer have been among the top ten causes of death in the United States. In fact, cardiovascular disease (which includes heart disease, stroke, high blood pressure, heart failure and several other conditions such as arrhythmias, atrial fibrillation, cardiomyopathy and peripheral arterial disease) has been the leading cause of death in the U.S. every year since 1900 except during the 1918 flu epidemic. For quite some time now, cancer has finished in second place on that list. In recent years, diseases of the heart and cancer were responsible for causing 50% or more of all deaths in the U.S., thus equaling or outnumbering all other causes of death combined. A 2007 report of the American Heart Association indicates that cardiovascular disease and cancer were responsible for 59% of all deaths in the U.S. in 2004 (the most recent year for which complete statistics were available).

Cardiovascular disease is closely related to another significant health concern: obesity. Obesity is a condition in which the natural energy reserve, stored in the fatty tissue of humans and other mammals, exceeds healthy limits. Obesity is commonly defined as a Body Mass Index or “BMI” (weight divided by height squared) of 30 kg/m² or higher. While the exact link between obesity and cardiovascular disease is complex and far from fully understood, there is no doubt that the two often go hand in hand.

The obesity epidemic, particularly in the U.S., is well-documented. Obesity has and continues to be a severe public health crisis. Experts agree that as more and more obese children become obese adults, the diseases associated with obesity—such as heart disease, cancer and especially diabetes—will surge. Speculation is that the costs of these illnesses will be astronomical. Despite the new attention paid to obesity by doctors, researchers and the media, no discernable progress has been made in fighting obesity. According to most experts, it looks almost certain that obesity will get worse before it gets better.

The World Health Organization (WHO), for instance, believes that obesity is probably the fastest emerging health problem in both developed and developing countries because it has several major downstream health consequences in terms of diabetes, cardiovascular disease, several cancers, and arthritis—ailments that are very common and very expensive to treat. The WHO has also observed that no country has a track record in terms of attenuating and reversing the obesity epidemic.

A large number of medical conditions have been associated with obesity. Health consequences are categorized as being the result of either increased fat mass (osteoarthritis, obstructive sleep apnea, social stigma) or increased number of fat cells (diabetes, cancer, cardiovascular disease, non-alcoholic fatty liver disease). Mortality is increased in obesity, with a BMI of over 32 being associated with a doubled risk of death. There are alterations in the body's response to insulin (insulin resistance), a proinflammatory state and an increased tendency to thrombosis (prothrombotic state).

Disease associations may be dependent or independent of the distribution of adipose tissue. Central obesity (male-type or waist-predominant obesity, characterized by a high waist-hip ratio), is an important risk factor for “metabolic syndrome.” Metabolic syndrome is a combination of medical disorders, i.e., the clustering of a number of diseases and risk factors (including diabetes mellitus type 2, high blood pressure, high blood cholesterol, and triglyceride levels/combined hyperlipidemia), that heavily predispose and increase the risk of developing cardiovascular disease. Apart from metabolic syndrome, obesity is also correlated with a variety of other complications.

Not surprisingly, most researchers have concluded that the combination of an excessive nutrient intake and a sedentary lifestyle are the main cause for the rapid acceleration of obesity in Western society in the last quarter of the 20th century. The recommended treatment for obesity is even less surprising: reduce body fat by eating fewer calories and exercising more.

There are many, many causes and factors contributing to the obesity epidemic. It is widely believed that one of those causes is the consumption of more than a minimal amount of red meat. There is little doubt that excess body fat and regular consumption of red meat can have health-related consequences.

In nutrition, “red meat” is synonymous with “mammal meat.” The term is often considered misleading, as not all mammal meat appears red, and some non-mammal meat can be red. According to the USDA, all meats obtained from “livestock” are “red meats” because they contain more myoglobin than chicken or fish. Given the intense focus on nutritional concerns raised by the consumption of “red” meat, meat producers have been eager to have their products considered as “white.” For example, the U.S. National Pork Board has positioned pork as “the other white meat,” alongside poultry; however, meats which are red when raw and turn white on cooking, like pork, are categorized by the U.S. Department of Agricultural as red meats. Other red meats include beef, mutton and horse.

While red meat is a good source of complete protein and iron, its regular consumption presents several health risks, largely due to the saturated fat content of many cuts. Recent studies indicate that red meat could pose a notable increase in cancer risk. For example, recent findings from the World Cancer Research Fund and the American Institute for Cancer Research indicate that excess body fat and red meat are significantly linked to an increased risk of several types of cancer, including breast cancer, colorectal cancer, stomach cancer, lymphoma, bladder cancer and prostate cancer. Furthermore, there is convincing evidence that consumption of beef, pork, lamb and goat from domesticated animals is a cause of colorectum cancer.

Red meat's high saturated fat content is also associated with cardiovascular diseases. Furthermore, regular consumption of red meat has been linked to bone loss, type 2 diabetes, hypertension and arthritis.

The continued prevalence of heart disease and cancer, the increased attention given to the obesity epidemic by scholars and the media, and the significant increase in information that is now available, have all combined to produce massive behavioral and societal changes over the last 50 years. These changes have been fueled exponentially in the last decade or so as huge amounts of information became available via the Internet.

Beginning with the jogging boom of the 1970's, exercise took on a much more significant role than at any time in history prior to that point. Today, nearly all Americans have been persuaded that physical activity is essential to good health.

In addition to the fitness revolution, the past several decades have seen a concerted effort on the part of many people to improve their health by changing their eating habits, and in particular by (a) making healthier foods, such as salads and the like, a greater part of their daily diet, and (b) reducing or eliminating the amount of red meat they consume.

Another phenomenon that cropped up around the same time as the fitness craze was the salad craze. Salad bars started out as a novelty in the 1970's. Since then, they have become fixtures at both eat-in and take-out restaurants—to the point where a salad bar is now a firmly entrenched dining element. Aside from their popularity when it comes to eating out, salads are generally viewed as one of the most popular food items consumed by those who are trying to establish or maintain health-conscious eating habits. While salads may never be as popular in America as burgers and fries, it is safe to say that they are an integral part of many people's daily diets—particularly those trying to eat healthy. Some 6 million bags of ready-to-eat salad are sold in the U.S. every day.

Even fast-food restaurants have jumped on the salad craze. McDonald's® claims to have sold 80 million pounds of spring mix for its premium salads in 2005 to satisfy their salad-loving customers. The problem fast-food restaurants face, however, is the same problem individuals who make their own salads at home must contend with, namely, providing a salad that is tasty enough to maintain one's interest in continuing to eat salads, while at the same time avoiding the addition of too many unhealthy “toppings” to achieve that level of tastiness.

According to one standard, in order for a salad to be considered “low-fat,” it needs to be under three grams of fat. For it to be “low-calorie,” it would need to be 40 calories or less per serving. As such, eaters are encouraged to limit toppings such as croutons, bacon bits and sunflower seeds to a teaspoonful, and treat them as decorations or flavor enhancers, rather than a real part of the salad. At such a small level, many eaters will conclude “why even bother” to add such toppings? In response, they will either add much larger portions of such toppings than is recommended, or will continue to force themselves to eat bland salads having few if any toppings (which normally lasts only for a short time until the eater gets sick of having salads and returns to his or her prior eating habits).

Thus, a salad that is truly healthy (fat free or very low in fat) has a tendency to leave a lot to be desired when it comes to taste. If fast-food restaurants did not address this lack of taste, they almost certainly would have experienced poor sales of its salad products. An individual who fails to address this lack of taste in his or her own kitchen might very well grow to dislike salads, to the point where he or she completely falls off the healthy eating path and resorts to old (bad) habits. The inability to avoid cravings for tasty foods one used to consume, and/or the unavailability of substitutes that are adequate enough to stave off such cravings, is the downfall of all too many an attempt at improving one's eating habits.

To overcome the blandness problem, fast-food restaurants introduced an array of entree-sized salads, some featuring exotic greens, oranges, walnuts, cilantro and zingy new dressings. Hefty portions of meat and cheese are often added, making the word “salad” a bit of a misnomer. The fat-containing products added to provide improved taste often negate, or even overtake, the health benefits one was seeking by having chosen to eat a salad in the first place. It would come as no surprise if a person attempting to eat healthier learned, for example, that a McDonald's® Crispy Chicken Bacon Ranch Salad with dressing has more cholesterol and as many calories as a Big Mac® sandwich, decided he or she may as well simply go for the Big Mac®. They thus end up avoiding the salad option altogether, and perhaps eventually give up entirely on efforts to improve eating habits.

Similarly, those who make their own salads at home or at work are constantly seeking ways to enhance the taste of what might otherwise be a bland, unsatisfying bowl of lettuce. Yet the items many people add to “spruce up” a salad often thwart the attempt to eat healthy in the first place. Available “toppings” include processed salad dressings, pork and imitation bacon bits, cheese, croutons, salami/ham, fried meats, fried noodles, processed soy products and the like. Nutritionists, health professionals and doctors worldwide generally do not recommend any of such “toppings” because of their ingredients and/or fat, calorie or sodium content.

To the extent diet and nutrition commentators do allow for the occasional fast-food salad, they recommend that only very small portions of certain toppings be used. For example, such commentators equate the addition of bacon bits to the addition of cheese (in terms of negative diet impact), and encourage eaters to skip the addition of both. They further indicate that if an eater must have the taste of bacon bits, he or she should only do so by getting a small portion of bacon bits on the side. The trouble it takes for an eater to ask for bacon bits on the side, not to mention the guilt factor when he or she does break down and adds or leaves on the full portion of bacon bits (or even adds an extra portion), are both detrimental to sticking to any sort of healthy eating program.

In addition to exercising and increasing the quantity of healthy foods being ingested, many people have sought to reduce or eliminate the amount of so-called “unhealthy” foods from their diets, such as red meat. The difficulty for many in giving up red meat has much to do with the very thing that makes red meat less than healthy: fat. It is the fat content which is an integral part of the flavor and texture of many meats. One would think, therefore, that a meat with less fat would naturally have less taste. However, one lean meat emerged as a very satisfactory substitute for beef and red meat: turkey. People began to take notice of the fact that the use of turkey allowed one to create meals that did not sacrifice taste for nutrition.

Turkey has always been a flavorful, healthy protein. Additionally, it is widely held that turkey has superior convenience, versatility and taste equal to or better than red meat. Turkey is a better source of protein than other popular meats. A skinless, cooked 3-ounce turkey breast contains no saturated fat and 26 grams of protein—8% more protein than a 3-ounce skinless, cooked chicken breast or 3-ounce, cooked top loin steak trimmed of visible fat. Turkey also has a low cholesterol count, and is often referred to as a source of lean protein because it has less saturated fat, less total fat and less cholesterol than chicken, pork or beef.

During the last two decades, the turkey industry has come from a single-product, holiday-oriented business into a fully integrated industry with a diversified product line that competes with other protein products on a year-round basis in nearly every category. In response to changing prices as well as health concerns about saturated fat and cholesterol, consumers have altered their consumption of various meats. One USDA report points out that consumption of beef in the U.S. between 1970-1974 and 1990-1994 dropped by 21%. By comparison, turkey consumption has increased 106% since 1970, due to consumers' recognition of turkey's good taste and nutritional value.

With the relatively recent surge in popularity of various “fad” diets (such as the Atkin's low-carbohydrate diet), turkey's high-protein, low-fat content makes it an ideal food for the tens of millions of Americans following such diets.

Despite the availability of turkey, many people still have a difficult time reducing or eliminating their red meat consumption. Perhaps one of the tastiest and most universally enjoyed red meat products is bacon. Bacon is any of certain cuts of meat taken from the sides, belly or back of a pig that may be cured and/or smoked. Meat from other animals may also be cured or otherwise prepared to resemble pork bacon, such as beef, lamb, chicken, goat or turkey bacon. In the U.S., ordinary bacon is only made from the pork belly, yielding what is known in Britain as “streaky bacon” or “streaky rashers.” The USDA defines bacon as “the cured belly of a swine carcass,” while other cuts and characteristics must be separately qualified (e.g., “smoked pork loin bacon”). “USDA Certified” bacon means that it has been treated for trichinella.

Bacon is smoky, salty and in most people's opinion delicious. Unfortunately, it is completely saturated with fat. Whether applewood smoked, maple cured, thick cut, or thinly sliced, bacon is considered one of the more unhealthy options in the typical American diet. A 2007 study by Columbia University suggests a link between eating cured meats, such as bacon, and chronic obstructive pulmonary disease. The preservative sodium nitrate is the probable cause.

Just as turkey emerged as an acceptable substitute for beef, so too has turkey bacon become a more than acceptable substitute for pork-based bacon. For example, two strips of genuine bacon may have about 80 calories, 8 grams of fat (3.5 grams of saturated fat), 300 milligrams of sodium and 4 grams of protein. By way of comparison, two strips of a typical turkey bacon product may have about 40-60 calories, 0-2.5 grams of fat (0-1 grams of saturated fat), 250-350 milligrams sodium and 6-7 grams protein.

In the United States and Europe, bacon is often used as a condiment or topping on other foods. Strips of streaky bacon are more commonly used as a topping in the U.S., on items such as pizza, salads, sandwiches, hamburgers, baked potatoes, hot dogs and soups. Back bacon is used less frequently in the U.S., but can sometimes be found on pizza, salads and omelets.

Bacon bits are chopped pieces of pre-cooked bacon. Bacon bits and pieces are used in a variety of ways with a variety of foods. For example, bacon bits and crumbles are used in salad bars, and as flavor ingredients/enhancers for soups and vegetables. Bacon pieces are used in connection with egg dishes, such as omelets and quiches, as well as other food traditionally eaten at breakfast time such as muffins, pancakes, etc. Bacon pieces may also be used in dips, or added to baked potatoes, wraps, baked beans, spinach, sandwiches, green beans, peas, casseroles and the like. Bacon chips find use as a pizza topping.

In addition to falling in the red meat category, genuine (i.e., pork-based) bacon bits contain harmful preservatives called sodium nitrites, along with large amounts of saturated fats and sodium. Imitation bacon bits are available, and although lower in fat and typically made of vegetable protein, they are still highly processed and not very nutritious.

While every individual's tastes and preferences are different, often imitation bits may come close to replicating one or another quality of genuine bacon (such as taste, texture, appearance, etc.), but—despite marketing claims to the contrary—usually do not match genuine bacon bits in all respects. That is, an imitation bacon bits product that has a very similar taste to genuine bacon bits may fall short in terms of appearance and texture. An imitation bacon bits product that looks very much like genuine bacon bits and has a very similar texture often has a taste which is easily distinguishable from (and not nearly as good as) genuine bacon bits. Therefore, while imitation bits avoid many of the negative nutritional implications of true bacon bits, they fall short in other respects and thus do not constitute an ideal substitute for real bacon bits.

Bacon bits are at a unique crossroads for someone looking to not only decrease the intake of red meat but also increase the consumption of healthier foods such as salads that have enough taste to keep maintain the person's interest (without adding toppings or the like that end up negating any nutritional benefits). Bacon bits are one of those items that (a) may be difficult to resist for someone who previously had a liking for bacon; (b) is made from a product which the person is trying to avoid, namely, red meat; (c) would add substantially to the taste of a salad (making it more desirable and increasing the chances that one will continue to eat salads), yet (d) will detract from the nutritional value provided by an identical salad having no bacon bits; and (e) perhaps most importantly, there is no suitable healthier alternative to substitute in place of genuine pork-based bacon bits, unless of course one is willing to tolerate the soy-based bits and other imitation/chemically compounded options currently on the market and marketed as “bacon” bits substitutes.

Thus, a need exists for a food topping made from a healthier white-meat-based product such as turkey, which can be added to food products such as salads and used in place of red-meat-based products such as genuine, pork-based bacon bits.

The need also exists for a food topping made from turkey meat that can be used in place of artificial toppings such as soy-based bits.

The need also exists for a turkey seasoning that is lower in sodium, saturated fat, unsaturated fat, sugar and/or calories so as to provide a healthier alternative to known seasoning products.

The need also exists for turkey bits which provide equal or superior texture, look and flavor compared to that of known bacon bits and artificial bacon bits products currently on the product.

For individuals who—for one reason or another—are strictly prohibited from consuming pork products, the need exists for a food topping that tastes like bacon.

The need also exists for a method of producing turkey “bacon” bits in a manner which yields a product that is identical or nearly identical to genuine pork-based bacon bits in qualities such as taste, texture and appearance.

### BRIEF SUMMARY OF THE INVENTION

The inventor of the present invention has found, surprisingly, that by combining certain ingredients and employing particular cooking techniques, a topping bits product can be produced that is indistinguishable in all relevant respects from true pork-based bacon. Because it consists of poultry meat such as turkey rather than pork, the product of the present invention is far healthier than genuine bacon bits.

The turkey bacon bits of the present invention provide a food topping which is significantly lower in sodium content, saturated and unsaturated fat, sugar and calories than competing products on the market. Not only does the present invention thus yield a healthier alternative, it surprisingly does so without sacrificing important qualities such as taste and appearance. The turkey bits of the present invention provide a texture, look and full flavor that is at least equal to—if not better than—similar known products. Moreover, the turkey bits of the present invention are produced with all natural ingredients. When added to typically healthy meals such as salads and the like, the product of the present invention enhances the taste of such meals, thereby encouraging eaters to maintain a desire for healthy meals rather than losing interest due to meals that are inherently bland.

### DETAILED DESCRIPTION OF THE INVENTION

The disclosure now turns to a discussion of various details that may be incorporated in accordance with at least one presently preferred embodiment of the present invention. The details discussed hereinbelow are meant to be illustrative instead of restrictive, and it thus should be understood that there remain a very wide variety of possible implementations for poultry bits and methods within the spirit and scope of the present invention.

At its most basic level, the topping bits of the present invention are made in accordance with a process that involves preparing a brine solution consisting of various ingredients to be discussed in more detail below, preparing the pieces of poultry meat for application of the brine solution, soaking the prepared poultry slices in the brine for a period of time during which various stirring, shuffling and shaking stages take place at given intervals, removing and rinsing the brine-treated poultry pieces, subjecting them to a particular series of drying steps, and then chopping the slices into bits and performing any other final steps necessary to yield an end product that is ready to be packed and shipped.

As a representative sample, embodiments of the present invention are discussed below in the context of bits made from turkey meat. It should be noted, however, that the present invention is not limited to turkey, but rather applies to other types of poultry meat as well.

Most preferably, the turkey utilized in the process of the present invention is turkey thigh meat. Turkey thighs give a higher similarity to the appearance of traditional pork-derived bacon bits, giving enhanced “eye appeal” to the consumer and better product relation to the current commercially-available bits products. Also, the fat content or marbling of the turkey thigh is such that it produces the most superior end-product as compared to meat from other parts of the turkey. As compared to meat from other poultry, the turkey thigh has more taste and depth than that of a chicken thigh for example. Certainly, however, it is perfectly fine to use either white or dark meat.

Meat from the turkey's leg would be a suitable alternative to its thigh meat, giving very good quality. However, use of leg meat is more labor-intensive because to remove the meat from the bone the leg must be grasped by the little end and sliced downward with the blade of a very sharp knife against the bone. Also, legs include long, tough, stringy tendons that may not be considered tasty. It is contemplated within the scope of the present invention that other poultry, including but not limited to chicken, Emu and fowl, and other non-red meat sources could be used in place of or in combination with turkey meat.

The brine or flavor-imparting mixture in which the turkey pieces are cured includes three primary ingredients: water; salt; and a flavoring agent which includes one or more flavor constituents. Preferably, in one embodiment the brine or flavor-imparting mixture is made up of (by volume percentage) approximately 45-85% water, 1-10% salt, 8-22% flavor constituent and 2-14% sugar (the flavor constituent and sugar together comprising the flavoring agent). More preferably, the brine or flavor-imparting mixture includes approximately 65-80% water by volume, 2-6% salt, 11-17% flavor component and 4-11% sugar (the flavor component and sugar together comprising the flavoring agent). In a most preferred embodiment, the brine or flavor-imparting mixture of the present invention consists of about 72% water by volume, 5% salt, 14% flavoring constituent and 9% sugar (the flavor constituent and sugar together comprising the flavoring agent).

Essentially any potable water may be used in the brine, including even tap water. More preferably, spring or well water is used. Most preferably, chilled (approximately 32-42° F.) purified drinking water is used. “Purified water” (also sometimes referred to “filtered water”) essentially refers to water from which most or all impurities have been removed but essential minerals are left behind, usually done through a process of reverse osmosis. Chilling of the water prevents bacteria from forming/growing. Warm water would not only encourage bacterial growth but would promote a light cooking (curing), which in turn would affect the meat's curing time in the flavor-imparting mixture because such meat would not as readily absorb the brine as it would using raw meat.

With regard to the salt component, any suitable edible salt may be used. More preferably, iodized salt, sea salt, or kosher salt is used. Most preferably, non-iodized salt is used. Non-iodized salt is less expensive compared to many of the other salts, and yet still results in a high-quality end-product. Specialty salts, such as organic sea salt, may also be used but are typically more expensive. Combinations of two or more salts may also be used.

By way of mere illustration, and intending in no way to be limiting, the following are a few of the different types of salts which the inventor of the present invention has considered and/or experimented with:

Frontier® Non-Iodized Sea Salt (described as “fine grind, unrefined, containing trace elements from the ocean”), the ingredients of which according to the product label are “sea salt and magnesium oxide (an anti-caking agent),” and which according to the label's nutritional information has 630 mg sodium in a 1.5 g serving size;

Morton® Non-Iodized Sea Salt (described as “fine salt”), the ingredients of which according to the product label are “salt, and Yellow Prussiate of soda (an anti-caking agent),” and which according to the label's nutritional information has 560 mg sodium in a 1.5 g serving size;

Hain Pure Foods® Non-Iodized Sea Salt (described as having been “made from evaporated sea water”), the ingredients of which according to the product label are “salt, and calcium silicate (an anti-caking agent),” and which according to the label's nutritional information has 590 mg sodium in a 1.5 g serving size;

Hain Pure Foods® Iodized Salt (described as having been “made from evaporated sea water”), the ingredients of which according to the product label are “salt, calcium silicate (anti-caking agent), dextrose, potassium iodide and sodium bicarbonate,” and which according to the label's nutritional information has 590 mg sodium in a 1.5 g serving size and 45% iodine;

Morton® Iodized Salt, the ingredients of which according to the product label are “salt, calcium silicate, dextrose and potassium iodide,” and which according to the label's nutritional information has 590 mg sodium in a 1.5 g serving size and 45% iodine; and

Morton® Non-Iodized Salt, the ingredients of which according to the product label are “salt and calcium silicate,” and which according to the label's nutritional information has 590 mg sodium in a 1.5 g serving size.

With regard to the flavoring agent, while it need not contain more than one flavor constituent it ordinarily includes at least two constituents, the first of which is most often sugar. Any suitable sugar may be used. Selection of the type of sugar(s) to use will largely depend upon the desired flavor and color one wishes to achieve in the end-product. More preferably, light brown sugar is used. Most preferably, dark brown sugar is used due to its color and stronger flavor profile. Combinations of different sugars may also be used, so long as it is understood that any combination that includes less-than-dark sugar will result in a lighter colored end-product, and may affect—perhaps only minimally—the depth of the taste and flavor profiles.

Assuming the flavoring agent does not consist of entirely sugar, a second flavor constituent may be added. Any suitable flavor-adding substance can be utilized, but most preferably is soy sauce. Other types of sauces that the present inventor has discovered yield a turkey topping that is virtually indistinguishable from true bacon bits include but are not limited to tamarind sauce, hoisin sauce, Braggs Amino Acid combination, and mixtures thereof.

By way of mere illustration, and intending in no way to be limiting, the following are a few of the different types of soy sauces which the inventor of the present invention has considered and/or experimented with:

Kikkoman® All-Purpose Naturally Brewed Soy Sauce, the ingredients of which according to the product label are “Water, wheat, soybeans, salt, sodium benzoate (less than 1/10 of 1% as a preservative),” and which according to the label's nutritional information has 10 calories, 920 mg sodium, and 2 g protein in a 1 TBSP serving size;

Tamari Organic Wheat-Free Soy Sauce by San-J, the ingredients of which according to the product label are “water, organic soybeans, salt, and organic alcohol (to preserve freshness),” and which according to the label's nutritional information has 10 calories, 940 mg sodium, 1 g total carb., 2 g protein and 4% iron in a 1 TBSP serving size;

Tamari Naturally-Brewed, Reduced-Sodium, Premium Soy Sauce by San-J, the ingredients of which according to the product label are “water, soybeans, salt, alcohol (to preserve freshness) and wheat,” and which according to the label's nutritional information has 20 calories, 700 mg sodium, 1 g total carb., 1 g sugar, and 2 g protein in a 1 TBSP serving size; and

La Choy® Soy Sauce Salt (described as having been “made from evaporated sea water”), the ingredients of which according to the product label are “water, salt, hydrolyzed soy protein, corn syrup, caramel color, and potassium sorbate (preservative).” No additional information is provided on the product's label.

As one skilled in the art will recognize, the number of ingredients that are involved in the present invention translates into a significant number of different combinations or “recipes” that could be made. For example, if Ingredient A is replaced with Ingredient B, it may not be the case that no other adjustments in the “recipe” will have to be made. Instead, it is possible that some of the properties of Ingredient B will be different (perhaps only minimally, perhaps significantly) than those of Ingredient A, and thus when used in the recipe may interact differently with the other ingredients and/or impact the nature of the overall mixture. To compensate for such alterations, one skilled in the art would know to make various adjustments to the other ingredients (or to mixing techniques, times, temperatures, or whatever the case may be) in order to achieve the same or about the same overall desired mixture.

By way of example only, if Braggs Amino Acid combination was utilized in place of soy sauce, the amount of Braggs would need to be slightly increased as would the amount of salt added, due to Braggs having a lower sodium content than soy sauce. Similarly, using Tamari you could reduce the salt or use only ⅞ths the amount of Kikkoman soy sauce. Likewise with regard to the salt component, because Kosher grains occupy more volume (for equal weight), the volume of Kosher salt would be increased. Moreover, even within the kosher salt category salt grains can vary in size from one brand to another.

In addition to the main ingredients that make up the brine or flavor-imparting mixture (water, salt, and at least one flavoring agent), other ingredients such as red wine may be added to provide different flavor profiles. To achieve a smokey flavor, a small amount of liquid smoke could be added to the brine. In the most preferred embodiment, 1½ teaspoons of Wright's Hickory Seasoning Liquid Smoke is added to the flavor-imparting mixture. Alternatively, the step of smoking the product for the last 45 minutes to an hour of the drying process, using a pan of hickory wood chips in a smoker at approximately 120° F.

The process of the present invention can be used to produce all natural turkey bits made with organic ingredients for the distribution throughout the healthy grocer sector such as Fresh Fields, Wegmen's, Wild Oats, Tree of Life and Frontier.

If for some reason salt levels in the brine became so low that shelf life was being jeopardized, addition of some other shelf-stabilizing agent could be added. Although not within the preferred embodiment of the invention, numerous phosphates (such as sodium tripoly phosphate, sodium poly phosphate glassy, sodium pyrophosphate, and sodium acid pyro phosphate) and nitrates or nitrites may be used.

The turkey bits of the present invention are particularly appealing to those who are desirous of adding a bacon-flavored bit, chip or piece to complement a particular food item yet for one reason or another simply cannot do so because they are strictly prohibited from consuming any type of pork-based products, whether due to extreme dietary restrictions, religious reasons, or the like.

### EXAMPLE 1

A commercially-available real bacon pieces product was obtained and its back panel analyzed for ingredient and nutritional information, namely, a 2.8 oz (79 g) glass jar of Hormel® “Real Bacon Pieces.” On the front panel of this product the following was printed: “50% Less Fat THAN USDA DATA FOR PAN-FRIED BACON.” The listed ingredients of this product are as follows: BACON (CURED WITH WATER SALT, SODIUM ERYTHORBATE, SODIUM NITRATE. MAY ALSO CONTAIN SMOKE FLAVORING, SUGAR, DEXTROSE, BROWN SUGAR, SODIUM PHOSPHATE, POTASSIUM CHLORIDE, FLAVORING).

The nutritional information is provided on the back panel of this product, for a serving size of 1 Tbsp (7 g)—of which it states there are about 11 in the container. The back panel also states: “FAT CONTENT HAS BEEN REDUCED FROM 3 g OF FAT TO 1.5 g PER SERVING.” It further states “1 TBSP IS EQUIVALENT TO 1 SLICE OF FULLY COOKED BACON.” It indicates on the back panel immediately below the nutritional information that the product is “[n]ot a significant source of Trans Fat, Dietary Fiber, Sugars, Vitamin A, Vitamin C, Calcium and Iron.” Instructions are printed on the side of the jar to “REFRIGERATE AFTER OPENING.” The nutritional information reads as follows:

| | | | % Daily Value |
|---|---|---|---|
| | | | (based on a 2,000 calorie diet) |
| Calories | 25 | | |
| Calories from Fat | 15 | | |
| Total Fat | 1.5 | g | 2% |
| Saturated Fat | 0.5 | g | 3% |
| Cholesterol | 5 | mg | 2% |
| Sodium | 200 | mg | 8% |
| Total Carbohydrate | 0 | g | 0% |
| Protein | 3 | g | |

### EXAMPLE 2

A second commercially-available product was obtained and its back panel analyzed for ingredient and nutritional information, namely, a 4.1 oz (116 g) jar of Betty Crocker® “Bac-Os®”, described on the front panel of this plastic jar as “BACON FLAVORED, ARTIFICALLY FLAVORED CHIPS.” On the front panel of this product the following was also printed: “NO SATURATED FAT,” below which was printed the words “NO CHOLESTEROL.” The listed ingredients of this product are as follows: DEFATTED SOY FLOUR, PARTIALLY HYDROGENATED SOYBEAN OIL, WATER, SALT, SUGAR, NATURAL AND ARTIFICIAL FLAVOR, ARTIFICIAL COLOR AND RED 40, MALTODEXTRIN, DEXTROSE, TOCOPEROL (PRESERVATIVE). It indicates on the back panel immediately below the list of ingredients that the partially hydrogenated soybean oil component “adds a trivial amount of trans fat,” that the product “CONTAINS SOY INGREDIENTS,” and that the product “CONTAINS NO MEAT OR ANIMAL FAT.”

The nutritional information is provided on the back panel of this product, for a serving size of 1½ Tbsp (7 g)—of which it states there are about 16 in the container. The back panel also states: “FAT CONTENT HAS BEEN REDUCED FROM 3 g OF FAT TO 1.5 g PER SERVING.” It further states “1 TBSP IS EQUIVALENT TO 1 SLICE OF FULLY COOKED BACON.” It indicates on the back panel immediately below the nutritional information that the product is “[n]ot a significant source of dietary fiber, sugars, vitamin A, vitamin C and calcium.” Instructions are printed on the side of the jar to “Refrigerate After Opening for added freshness and convenience.” The nutritional information reads as follows:

| | | | % Daily Value |
|---|---|---|---|
| | | | (based on a 2,000 calorie diet) |
| Calories | 30 | | |
| Calories from Fat | 10 | | |
| Total Fat | 1.5 | g | 2% |
| Saturated Fat | 0.5 | g | 3% |
| Trans Fat | 0 | g | |
| Polyunsaturated Fat | 0 | g | |
| Monounsaturated Fat | 0.5 | g | |
| Cholesterol | 0 | mg | 0% |
| Sodium | 115 | mg | 5% |
| Potassium | 115 | mg | 3% |
| Total Carbohydrate | 2 | g | 1% |
| Protein | 3 | g | |
| Iron | | | 2% |

### EXAMPLE 3

A third commercially-available product was obtained and its back panel analyzed for ingredient and nutritional information, namely, a 3.25 oz (92 g) jar of McCormick® “Bac'n Pieces,” described on the front panel of this plastic jar as “BACON FLAVORED BITS.” On the front panel of this product the following was also printed: “NO CHOLESTEROL,” as well as the words “ARTIFICIALLY FLAVORED.” The listed ingredients of this product are as follows: TEXTURED SOY FLOUR, PARTIALLY HYDROGENATED SOYBEAN OIL, SALT, CORN STARCH, NATURAL AND ARTIFICIAL FLAVORS, CARAMEL COLOR, HYDROLYZED SOY PROTEIN, CORN GLUTEN, AND WHEAT PROTEIN, FD&C RED 3, AND AUTOLYZED YEAST.

The nutritional information is provided on the back panel of this product, for a serving size of 1½ Tbsp (7 g)—of which it states there are about 13 in the container. It indicates on the back panel immediately below the nutritional information that the product is “[n]ot a significant source of Saturated Fat, Trans Fat, Dietary Fiber, Sugars, Vitamin A, Vitamin C, Calcium.” No instructions regarding refrigeration or the like are provided. The nutritional information reads as follows:

| | | | % Daily Value |
|---|---|---|---|
| | | | (based on a 2,000 calorie diet) |
| Calories | 30 | | |
| Calories from Fat | 15 | | |
| Total Fat | 1.5 | g | 2% |
| Cholesterol | 0 | mg | 0% |
| Sodium | 220 | mg | 9% |
| Potassium | 115 | mg | 3% |
| Total Carb. | 2 | g | 1% |
| Protein | 3 | g | |
| Iron | | | 2% |

### EXAMPLE 4

For purposes of comparing the above three commercially available bacon-flavored salad toppings, a preferred embodiment of the turkey bits product of the present invention was made in accordance with a preferred embodiment of the method of the present invention, using 8 lbs. of turkey meat and a brine consisting of the following ingredients: 2 quarts sodium-free drinking water; 1½ cups soy sauce; 1½ teaspoons liquid, all-natural hickory smoke; 140 milliliters non-iodized salt; and 1 cup of dark brown sugar.

Starting with partially frozen skinless/boneless turkey thighs, the thighs were rinsed under cold water and any excess fat was cleaned off. A partially frozen turkey thigh is much easier to cut on the deli slicer and provides for a more uniform piece, which allows the pieces to finish cooking/drying within a closer time range to each other. After cold water rinsing and cleaning off excess fat, the thighs were then cut, as equally as possible, preferably into slices measuring approximately ½″ to ¾″ wide and approximately 2½″ to 3¼″ long. Of course, the pieces could be cut skinnier or wider if desired. Pieces sliced using a deli slicer come off as long as 6-8 inches and as small as ¾ of an inch. The thickness can suitably range between ⅛ inch to ½ inch but would effect the cooking/drying time significantly.

Next, the chilly thigh slices were immediately placed into containers of the above-described chilly brine solution. Plastic, glass and metal containers have been used with no noticeable difference. The containers are covered with a lid and placed into refrigeration for about 6-7 hours, at which point the container was shaken/shuffled to stir the brine and meat and placed back into refrigeration. About 45 minutes thereafter the brine/meat was stirred very well with a wooden space and placed back into refrigeration, and then about 1 hour after that given another wooden spoon stir (this time using a light to medium stir). Another more vigorous stir was applied 1 hour after that, at which time it was observed that the turkey meat was beginning to show a noticeably darker color. About 45 minutes later a final stir was applied, and then after about another 40 minutes the containers were pulled from refrigeration and a cold water rinse applied for approximately 4 minutes.

The intervals between stirring or shaking could be much longer or shorter than noted in this Example, as long as they are relatively staggered. The main goal is to make sure the brine is curing at a sufficient rate, and to keep the ingredients from settling or separating. Failure to do the latter runs the risk of giving some pieces in the brine a more enhanced saturation of one ingredient over another.

Next, the turkey thigh slices were drained in a colander, patted dry, and placed onto racks. The racks were placed into an oven at 200° F. with a drip pan under the racks. It is important that the temperature be closely monitored. A higher quality product is achieved via a relatively slow bake at a relatively low temperature. Attempting to cook/dry the turkey slices too fast, at too high a temperature, would cause various negative consequences such as drying out of the product to the point of it being brittle, crumbling, and having a bad taste. In a normal oven a most preferred temperature range is between about 195-212° F. If instead a dehydrator is used, the temperature would preferably be between about 140-155° F.

About 2½ hours later after first placing the racks in the oven, the drip pans were pulled from the oven to allow a more even flow of heat. After another 2½ hours, the pans were checked and it was observed that the turkey slices on the top and bottom racks were more cooked than those in the middle, so the racks were shuffled/rotated accordingly and left in the oven for approximately 30 more minutes. At that time, the racks were pulled and placed on top of the oven under the fan set to “high.”

After about 15 minutes underneath the fan, the pieces were inspected and it was observed that a few pieces still exhibited a water/oily content greater than desired and so the racks were placed back into the oven at 200° F. After about 20 minutes of baking time, the racks were inspected and the pieces that appeared filly cooked were removed. The remaining pieces were baked for an additional 10 minutes or so, removed, and then all slices were patted dry on both sides so that any moisture/oil/water content would be less of a factor in terms of causing a deterioration of the maximum shelf life. The slices are then made into bits via appropriate cutting and/or chopping means.

### EXAMPLE 5

Based on a serving size of 7 grams of the finished product derived from Exhibit 4, a nutritional analysis was performed, the results of which are set forth below:

| | | | % Daily Value |
|---|---|---|---|
| | | | (based on a 2,000 calorie diet) |
| Calories | 20 | | |
| Calories from Fat | 5 | | |
| Total Fat | 0.5 | g | 0.77% |
| Saturated Fat | 0.125 | g | 0.63% |
| Trans Fat | 0 | g | |
| Cholesterol | 16.25 | mg | 5.4% |
| Sodium | 287.5 | mg | 12% |
| Total Carb. | 0.5 | g | 0.2% |
| Dietary Fiber | 0 | g | |
| Sugars | 0.5 | g | |
| Protein | 3.25 | g | |
| Iron | | | 2% |

As can be seen from a comparison of the data set forth in Examples 1-4, in one embodiment of the present invention a bacon-like topping is produced which is lower in total calories, calories from fat, total fat and saturated fat than the commercially-available bacon bits products (both pork-based and imitation/soy-based), without sacrificing the levels of protein and iron. Furthermore, the product of the Example 4 embodiment of the present invention was at least as good as, if not much better than, the products of Examples 1-3 in terms of taste, texture, and visual appearance. Eaters who sample products made according to the present invention unanimously remarked that they could not tell the difference between such products and the commercially-available bacon bits products (both pork-based as well as imitation/soy-based). In many cases, eaters actually commented that they preferred the taste of the products made according to the present invention over the commercially-available bacon bits products, particularly as compared to the imitation/soy-based products.

The results set forth in Example 4 are presented merely by way of illustration only. They are in no way limiting, nor should they be construed as necessarily representative of the results that one can expect to obtain for all embodiments of the invention. As one skilled in the art will recognize, because there are numerous variables (in terms of selection of ingredients, processing steps, brining and cooking times and temperatures, thickness of the turkey slices, and so forth) that can be varied from one embodiment to another, the results above can similarly vary from one embodiment to another. For example, addition of 4 lbs. turkey meat to the same brine solution set forth in Example 4 in the same size container might likely yield nutritional values different than the ones set forth in Example 5.

Persons of ordinary skill in the art will appreciate that steps and processes described herein with reference to Example 4—if desired and appropriate—may be omitted, supplemented by other steps, performed in an order different from the above, or otherwise modified/altered to produce suitable poultry-based bits products. The steps and processes herein also may, without undue experimentation, be modified to produce bits products from poultry other than turkey, such as from Emu or fowl, as will be understood by those of ordinary skill in the art. Various devices also may be combined, or manual operators may be substituted by devices. Process steps could change, perhaps significantly, if, for example, meat other than a turkey thigh was used, owing to variations in fat, water content, marbeling and texture of the meat being used. Yes, due to the fat, water content, marbeling and texture of the meat being used. In addition, although the embodiments have been described with reference to certain preferred apparatus, it will be readily understood from the present teachings that similar devices may be used in place of many of the devices described herein. For example, it will be understood that a dehydrator could be used instead of an oven to perform the necessary drying function. Similarly, one skilled in the art would recognize that if, for example, a convection oven was used instead of a regular residential oven, the cooking/drying times would likely be different and thus watched carefully. Likewise, production of a large volume of bits via the use of an industrial-sized oven or the like would simply be a matter of scaling up and testing drying/cooking times due to the increased volume—something one skilled in the art would surely know to do and be capable of accomplishing without extraordinary effort. Variations other than the ones discussed herein will also be apparent to those skilled in the art.

Additionally, while the present invention has been described with particular reference to the drawings, it should be understood that various modifications could be made without departing from the spirit and scope of the present invention. It is also to be understood that the figures and descriptions of the present invention have been simplified to illustrate elements that are relevant for a clear understanding of the present invention, while eliminating, for purposes of clarity, other elements that may be well known. Those of ordinary skin in the art will recognize that other elements are desirable and/or required in order to implement the present invention. However, because such elements are well known in the art, and because they do not facilitate a better understanding of the present invention, a discussion of such elements is not provided herein. Further, throughout the instant disclosure, it will be appreciated that several terms may be used interchangeably with one another.

If not otherwise stated herein, it may be assumed that all components and/or processes described heretofore may, if appropriate, be considered to be interchangeable with similar components and/or processes disclosed elsewhere in the specification, unless an express indication is made to the contrary.

It should be appreciated that the compositions and methods of the present invention may be formulated and conducted as appropriate for any context at hand. The embodiments described above are to be considered in all respects only as illustrative and not restrictive. All changes which come within the meaning and range of equivalency of the claims are to be embraced within their scope.

Although the invention has been described in detail for the purpose of illustration based on what is currently considered to be the most practical and preferred embodiments, it is to be understood that such detail is solely for that purpose and that the invention is not limited to the disclosed embodiments, but, on the contrary, is intended to cover modifications and equivalent arrangements that are within the spirit and scope of the appended claims.

Although the invention has been described in terms of particular embodiments in an application, one of ordinary skill in the art, in light of the teachings herein, can generate additional embodiments and modifications without departing from the spirit of, or exceeding the scope of, the claimed invention. Accordingly, it is understood that the descriptions herein are proffered by way of example only to facilitate comprehension of the invention and should not be construed to limit the scope thereof.

Furthermore, although specific embodiments of the present invention have been described herein, it should be understood that such embodiments are by way of example only and merely illustrative of but a small number of the many possible specific embodiments which can represent applications of the principles of the present invention. Various changes and modifications obvious to one skilled in the art to which the present invention pertains are deemed to be within the spirit, scope and contemplation of the present invention.

The present invention has been described in considerable detail in order to comply with the patent laws by providing full public disclosure of at least one of its forms. However, such detailed description is not intended in any way to limit the broad features or principles of the present invention, or the scope of the patent to be granted.

What is claimed is:

1. A food topping in the form of bits, said bits comprising poultry meat that has been treated with a flavor-imparting mixture, said flavor-imparting mixture comprising:
water;
salt; and
a flavoring agent;
wherein said flavoring agent comprises at least one flavor constituent.

2. The food topping according to claim 1, wherein said poultry meat is turkey meat.

3. The food topping according to claim 2, wherein said flavoring agent comprises a first flavor constituent and a second flavor constituent, said first flavor constituent comprising sugar.

4. The food topping according to claim 3, wherein said second flavor constituent comprises soy sauce.

5. The food topping according to claim 5, wherein said sugar is dark brown sugar.

6. The food topping according to claim 2, wherein said water is chilled purified water.

7. The food topping according to claim 2, wherein said salt is non-iodized salt.

8. The food topping according to claim 2, wherein said turkey meat is turkey thigh meat.

9. The food topping according to claim 1, wherein said flavor-imparting mixture further comprises liquid smoke.

10. The food topping according to claim 1, wherein said flavor-imparting mixture comprises between about 45-85% water by volume, about 1-10% salt, and about 10-36% flavoring agent.

11. The food topping according to claim 10, wherein said flavor-imparting mixture comprises between about 65-80% water by volume, about 2-6% salt, and about 15-28% flavoring agent.

12. The food topping according to claim 11, wherein said flavor-imparting mixture comprises about 72% water by volume, about 5% salt, and about 23% flavoring agent.

13. The food topping according to claim 1, wherein said flavor-imparting mixture comprises between about 45-85% water by volume, about 1-10% salt, about 8-22% of a first flavor constituent and about 2-14% sugar, said first flavor constituent and said sugar together comprising said flavoring agent.

14. The food topping according to claim 13, wherein said first flavor constituent is soy sauce.

15. The food topping according to claim 1, wherein said water is non-iodized water, said salt is non-iodized salt, and said flavoring agent comprises sugar and soy sauce

16. The food topping according to claim 15, wherein said flavor-imparting mixture further comprises liquid smoke.

17. The food topping according to claim 1, said food topping having a serving size expressed in grams and further having calories from fat,
wherein the ratio of calories from fat to the number of grams of said serving size is between 0 and about 1.

18. A method for making a food topping in the form of bits, comprising the steps of:
treating pieces of poultry meat with a flavor-imparting mixture, said flavor-imparting mixture comprising;
water;
salt; and
a flavoring agent comprising at least one flavor constituent;
drying said pieces of treated poultry meat; and
cutting said dries pieces of treated poultry meat into bits.

19. The method of claim 18, wherein said poultry meat is turkey meat.

20. The method of claim 19, wherein said flavoring agent comprises a first flavor constituent and a second flavor constituent, said first flavor constituent comprising sugar.

21. The method of claim 20, wherein said second flavor constituent comprises soy sauce.

22. The method of claim 22, wherein said sugar is dark brown sugar.

23. The method of claim 19, wherein said water is chilled purified water.

24. The method of claim 19, wherein said salt is non-iodized salt.

25. The method of claim 19, wherein said turkey meat is turkey thigh meat.

26. The method of claim 18, wherein said flavor-imparting mixture further comprises liquid smoke.

27. The method of claim 18, wherein said flavor-imparting mixture comprises between about 45-85% water by volume, about 1-10% salt, and about 10-36% flavoring agent.

28. The method of claim 27, wherein said flavor-imparting mixture comprises between about 65-80% water by volume, about 2-6% salt, and about 15-28% flavoring agent.

29. The method of claim 28, wherein said flavor-imparting mixture comprises about 72% water by volume, about 5% salt, and about 23% flavoring agent.

30. The method of claim 25, wherein said flavor-imparting mixture comprises between about 45-85% water by volume, about I - 10% salt, about 8-22% of a first flavor constituent and about 2-14% sugar, said first flavor constituent and said sugar together comprising said flavoring agent.

31. The method of claim 30, wherein said first flavor constituent is soy sauce.

32. The method of claim 18, wherein said water is non-iodized water, said salt is non-iodized salt, and said flavoring agent comprises sugar and soy sauce

33. The method of claim 32, wherein said flavor-imparting mixture further comprises liquid smoke.

34. The method of claim 18, said food topping having a serving size expressed in grams and further having calories from fat,
wherein the ratio of calories from fat to the number of grams of said serving size is between 0 and about 1.
